(19) United States
(12) Patent Application Publication
(10) Pub. No.: US 2005/0157211 A1
(43) Pub. Date: Jul. 21, 2005

(54) Adjustable, waterproof video camera housing

(76) Inventors: Lary Hamilton Stucker, Garden Grove, CA (US); David John Johnson, Garden Grove, CA (US)

Correspondence Address: Lary Stucker, 12192 Brookhaven Park, Garden Grove, CA, 92840, US

(21) Appl. No.: 10/760,595

(22) Filed: Jan. 20, 2004

(51) Int. Cl. H04N 5/225

(52) U.S. Cl. 348/375

(57) ABSTRACT

A waterproof housing that contains a stabilization tray where a wide variety of video camera can be mounted and then controlled using an adjustable mechanism. The unit is sealed watertight and controlled by depressing a rubber endcap, which activates the adjustable record mechanism that in turn activates the video camera.

### BACKGROUND

1. Field of Invention

This invention is used in order to operate a wide variety of video cameras in aquatic environments that would otherwise be hostile to electronic devices.

### BACKGROUND

2. Description of Prior Art

Consumers use video cameras to record and document many of their events. When those events occur in environments that are hostile to electronic equipment, such as in or near the water, consumers had to use enclosures designed to keep their video cameras dry and yet still functional.

Therefore, inventors created several types of enclosures for protecting video cameras in these hostile environments.

The problem with prior housings is that they were either video camera specific, only fit a very narrow spectrum of video cameras, or had no control over the video camera once they were sealed inside.

Video camera technology changes so rapidly that in a few years a video camera becomes outdated. Many consumers who had previously purchased a housing that is camera specific or had a narrow spectrum of compatible video cameras are reluctant to purchase a new video camera because they have made such a large investment in that kind of housing.

Consumers who purchased housings with out any controls have found they are to limiting to enjoy the functionality of their video camera.

### OBJECTS AND ADVANTAGES

Accordingly, besides the objects and advantages of the housing described in my above patent, several objects and advantages of the present inventions are:
(a) To provide a housing that can adjust to fit the widest variety of video cameras on the market.
(b) To provide a housing that can control the pause/record function on the widest variety of video cameras on the market.

### SUMMARY

In accordance with the present invention a waterproof housing that has an adjustable mechanism within it that makes it compatible with a multiple video cameras.

### DRAWING FIGURES

In the drawings, elements have been designated with the same number regardless of the figure illustration.

FIG. 1 shows an exploded view of the button assembly as it relates to the stabilization tray.

FIG. 2 shows the back of the housing with the endcap (lid) removed.

FIG. 3 shows the front of the housing.

### DESCRIPTION

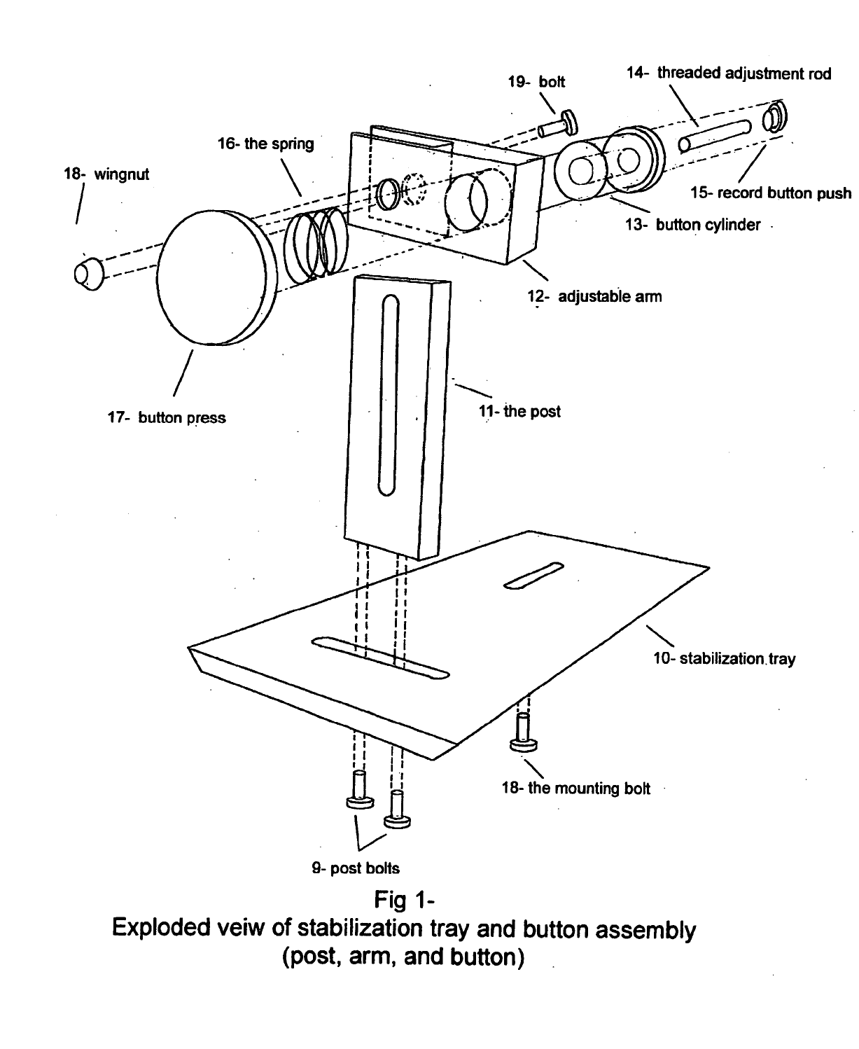

A typical embodiment of the adjustable record button is shown in FIG. 1. This is a perspective (exploded view) of the stabilization tray and the adjustable record button. The three main parts of this drawing are the 10 stabilization tray, 11—the post, and 12—the adjustable arm.

The 10—stabilization tray is where a video camera is mounted to using 18—the mounting bolt. 11—the post is also mounted to the tray using 9—post bolts. Both the camera and 11—the post is mounted onto slots in the tray so that they can be adjusted to fit different sized cameras.

11—the post is used to hold 12—the adjustable arm by 18—the Wingnut and 19—the bolt through the slot in 11—the post. This configuration allows both the length and the height of the button to be adjusted to line up with most makes and models of video camera.

12—the adjustable arm is comprised of 13—the button cylinder, which is the push rod that activates the record button on the video camera. Inside 13—the button cylinder is 14—the threaded adjustment rod, with attached 15—record button push. This allows the depth of the button cylinder to be increased to adapt to different video camera lengths.

17—the button press is welded to 13—the button cylinder through 12—the adjustable arm with 16—the spring in between 17—the button press and 12—the adjustable arm for a spring loaded device.

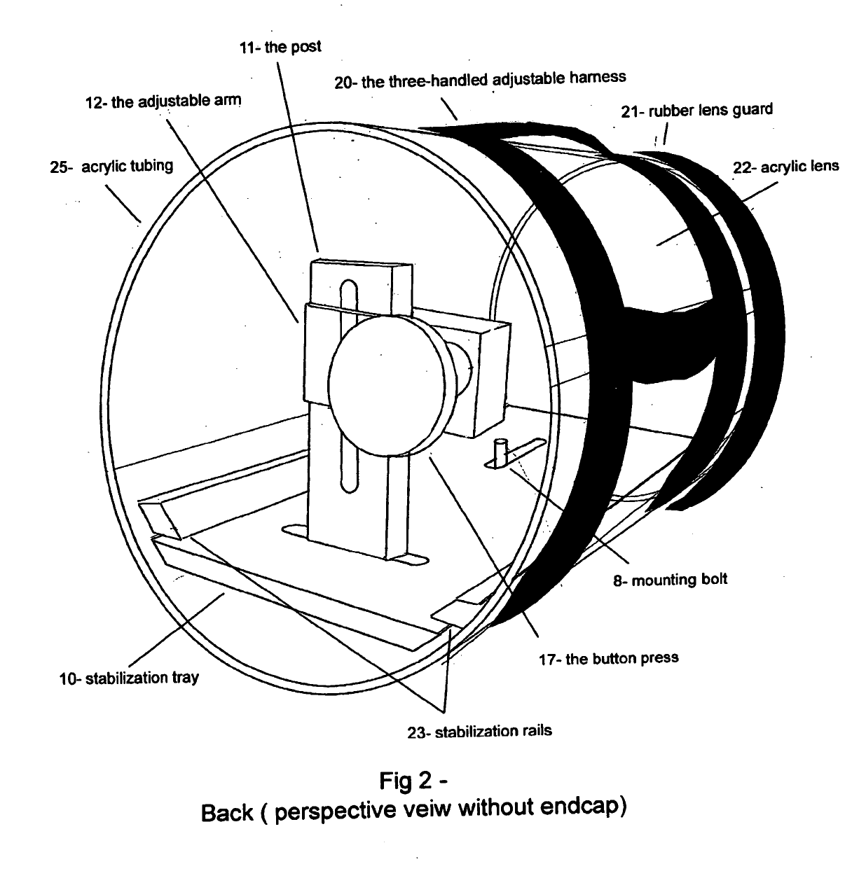

FIG. 2 shows the back view of the camera housing with the rubber endcap removed revealing the 23—stabilization rails and the placement of the 10—stabilization tray. It also shows 25—the cylinder haul, 22—the lens, 20—the three handled adjustable harness, and 21—the rubber lens guard.

23—the stabilization rails allow the tray with video camera and adjustable button assembly to slide into place and maintain a stable position within the waterproof housing.

25—the cylindrical haul provides the structure that protects the video camera from the elements. At the front end of the haul 22—the lens is welded to the haul creating a watertight seal. 22—the lens provides a clear viewing port for the video camera to record from.

20—the three-handled adjustable harness is made up of nylon tubing with band clamps thread through them so they may be tightly secured onto 22—the haul. Each handle has an adjustable strap so that they can accommodate many hand sizes.

21—the rubber lens guard protects the sides of the lens if an object strikes it.

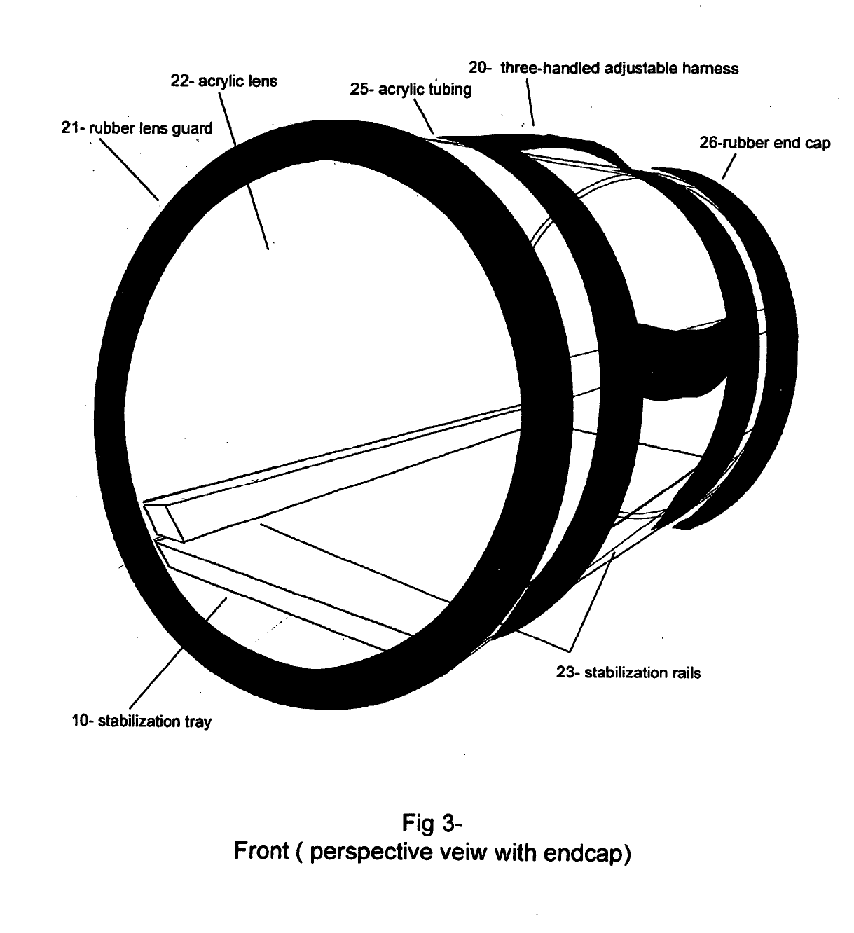

FIG. 3 shows a front view of the camera housing with 26—the rubber endcap in place. The drawing shows 21—the rubber lens guard, 23—the stabilization rails, 10—the stabilization tray, 20—the three-handled adjustable harness, 25—the haul, 22—the lens, 26—the rubber endcap with quick release buckle.

26—the rubber endcap fits securely over the open end of 25—the haul, and achieves a watertight seal by making use of a quick release buckle.

Operation

When a video camera is attached to securely mounted to 10—the stabilization tray using 8—the mounting bolt. 11—the post is then adjusted, along with 12—the adjustable arm, and 14—the threaded adjustment rod, so that the button assembly lines up with which ever make and model video camera is being used. Both 9—post bolts, and 18—the Wingnut are tightened down so that 11—the post, and 12—the adjustable arm will stay in place. The video camera is then powered up into a record/standby position and 10—the stabilization tray (with the mounted video camera and button assembly securely attached) is slid into place just below 23—the stabilization rails, within 25—the haul. Once FIG. 1 is in place within 25—the haul, 26—the rubber endcap is secured and the quick release buckle is secured creating a watertight seal. Now, with the video camera safely secured within the waterproof housing you can push against the back of 26—the rubber endcap. Doing so pushes against 17—the button press and compresses 16—the spring. This in turn causes 15—the record button push to depress the record/pause button on the video camera activating the record sequence. Pressing a second time on 26—the rubber endcap repeats the process this time causing the video camera to pause it's recording. The user of the adjustable, waterproof video camera housing is now able to operate the pause/record function of the video camera in environments that would be impossible without this invention.

### SUMMARY, RAMIFICATION, AND SCOPE

Accordingly, the reader will see that the waterproof, adjustable camera housing will allow said user to take their video camera snorkeling, surfing, swimming, boating, rainstorms, and any other activity that would typically expose a video camera to an environment hostile to it's proper operation.
it permits the user to use a wide variety of video cameras in a single camera housing.

1. A waterproof housing that functions with multiple video cameras comprising:
a. A haul to contain a video camera with a lens for viewing
b. A tray to mount said video camera and stabilize within said haul
c. An adjustable mechanism attached to said tray for controlling said video camera.
d. A lid for sealing said haul, making unit waterproof.
e. A means for activating said adjustable mechanism while said haul is sealed
